(19) United States
(12) Patent Application Publication
(10) Pub. No.: US 2006/0271873 A1
(43) Pub. Date: Nov. 30, 2006

(54) Method and apparatus for selecting image in image forming apparatus having display screen

(75) Inventor: Jeong-Seok Oh, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/443,024

(22) Filed: May 31, 2006

(30) Foreign Application Priority Data
May 31, 2005 (KR) 2005-46119

(51) Int. Cl. G06F 9/00

(52) U.S. Cl. 715/764; 715/856; 715/835; 715/810

(57) ABSTRACT

A method and apparatus for selecting an image in an image forming apparatus including a display screen are provided. According to the method, a mouse is connected to the image forming apparatus and a cursor of the mouse is moved on the display screen. Next, an image displayed on the display screen is selected using the cursor. The apparatus includes a mouse, a mouse driver, and an image selector. The mouse is connected to the image forming apparatus, and the mouse driver is installed in the image forming apparatus to allow the cursor of the mouse to move on the display screen. The image selector selects an image displayed on the display screen using the cursor of the mouse.

### CROSS-REFERENCE TO RELATED PATENT APPLICATION

This application claims the benefit under 35 U.S.C. § 119(a) of Korean Patent Application No. 10-2005-0046119, filed on May 31, 2005, in the Korean Intellectual Property Office, the entire disclosure of which is hereby incorporated by reference.

### BACKGROUND OF THE INVENTION

1. Field of the Invention

The present invention relates to an image forming apparatus. More particularly, the present invention relates to a method and apparatus for selecting an image in an image forming apparatus which uses a display screen.

2. Description of the Related Art

Many image forming apparatuses such as multi-functional peripherals (MFPs) or photo printers include a display screen to display an image thereon. When an image is stored in an image forming apparatus directly from an external digital apparatus (for example, a digital camera, a memory stick, a camcorder, or a camera phone) using a PictBridge function without using a host computer and the image is printed through the image forming apparatus, the image from the external digital apparatus is first displayed on the display screen. A user should use a menu by pressing a plurality of keys provided in the image forming apparatus so that an image displayed on the display screen can be selected and printed. However, it is quite difficult and inconvenient for the user to check and select a preferred image using the plurality of keys.

Accordingly, there is a need for an improved system and method to allow a user to check and select a preferred image without using a plurality of keys.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide a method and apparatus for selecting an image in an image forming apparatus. A display screen is included to allow a user to easily and quickly select a preferred image using a mouse cursor.

According to an aspect of an exemplary embodiment of the present invention, a method is provided for selecting an image in an image forming apparatus with a display screen. A mouse is connected to the image forming apparatus, a cursor of the mouse is allowed to move on the display screen, and an image displayed on the display screen is selected using the cursor of the mouse.

The image forming apparatus may have a USB (universal serial bus) host function and the mouse may be connected to the image forming apparatus through a USB port. The image displayed on the display screen may be input to the image forming apparatus directly from an external digital image device without using a host device connected to the image forming apparatus. The image selection may include selectively choosing a portion of the image. The image selection may also include using a predetermined menu. The menu may include an image enlargement menu for enlarging the image on the display screen or a resolution menu for selecting an image resolution to facilitate improvement of a printing speed.

According to another aspect of an exemplary embodiment of the present invention, an apparatus is provided for selecting an image in an image forming apparatus with a display screen. The apparatus includes a mouse connected to the image forming apparatus, a mouse driver installed in the image forming apparatus to allow a cursor of the mouse to move on the display screen, and an image selector to select an image displayed on the display screen using the cursor of the mouse.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other exemplary objects, features and advantages of certain exemplary embodiments of the present invention will be more apparent from the following description taken in conjunction with the accompanying drawings, in which:

FIG. 1 is a block diagram of an MFP with an inkjet printer using an apparatus and method according to exemplary embodiments of the present invention;

FIG. 2 is a block diagram of an image selector in an image forming apparatus including a display screen, according to an exemplary embodiment of the present invention; and

FIG. 3 is a flowchart of a method for selecting an image using a mouse in an image forming apparatus such as an MFP or a photo printer, according to an exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

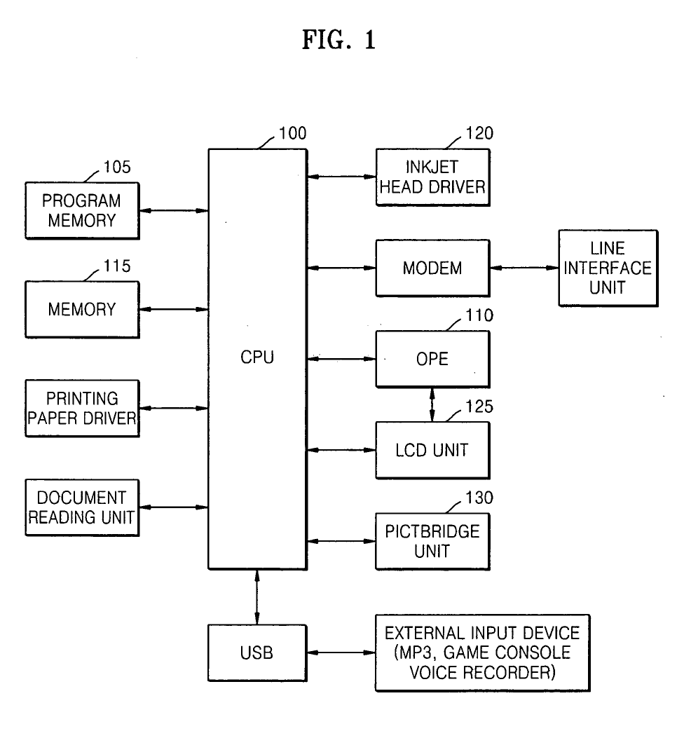

FIG. 1 is a block diagram of an MFP with an inkjet printer using an apparatus and method according to exemplary embodiments of present invention. Referring to FIG. 1, a central processing unit (CPU) 100 controls all the operations of the MFP using a program stored in a program memory 105. An operation panel (OPE) 110 includes a plurality of operation keys and light-emitting diodes (LEDs) or liquid crystal display devices (LCDs) for representing an operation status. The program memory 105 (for example, random access memory (RAM)) stores a program for the operation of the MFP. Another memory 115 (for example, dynamic random access memory (DRAM)) temporarily stores various data generated during the operation of the MFP.

An inkjet head driver 120 for driving an inkjet head includes a data transmission part (not shown) for transmitting print data to the inkjet head. The inkjet head driver 120 also includes a nozzle driving part (not shown) for operating each nozzle of the inkjet head in response to the transmitted print data. The inkjet head is a device for recording an image on paper. The inkjet head directly fires ink onto the paper under the control of the inkjet head driver 120. A liquid crystal display device (LCD) unit 125 displays an operation status when a command is delivered from the OPE 110 so that a user may easily recognize the operation status. That is, the LCD unit 125 displays an image input using a PictBridge unit 130 to the user. The PictBridge unit 130 allows an image to be directly input to the MFP from a digital camera or a memory card without using a computer, so that the user can select the image on the LCD unit 125 and print it.

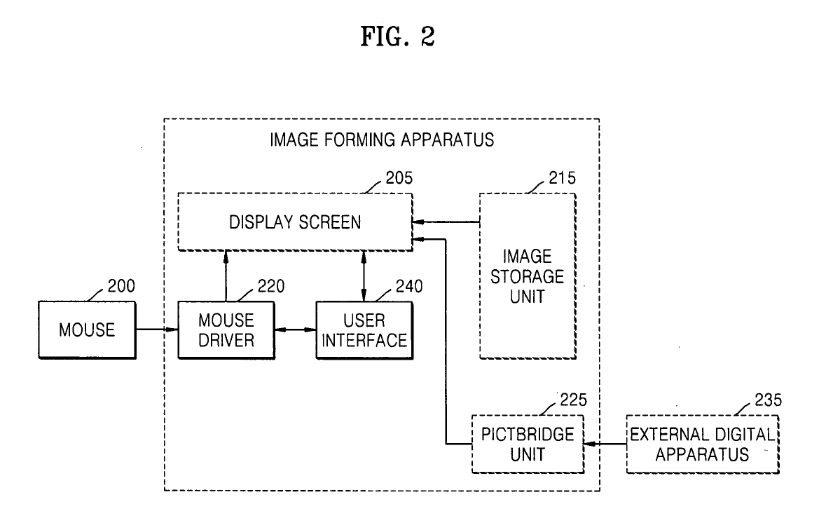

Exemplary embodiments of the present invention allow the user to easily select a preferred image by moving a mouse cursor on a display screen of the LCD unit 125 in the MFP. According to an exemplary embodiment of the present invention, it is possible to easily select a preferred image on the display screen of the LCD unit 125 and output the image input to the MFP printer using the PictBridge unit 130 and a universal serial bus (USB) port. The user connects a general mouse to the MFP. Next, the display screen of the LCD unit 125 then detects the mouse connected to the MFP (for example, a photo printer) and displays a mouse cursor. The user may then selectively output a preferred image using a plurality of menus selected by using the mouse. FIG. 2 is a block diagram of an image selector in an image forming apparatus including a display screen according to an exemplary embodiment of the present invention. The image selector includes a mouse 200, a mouse driver 220, and a user interface 240.

The mouse 200 is connected to the image forming apparatus with a USB host function through a USB port. The mouse driver 220 is installed in the image forming apparatus to drive the mouse so that a mouse cursor can move on a display screen 205 of the image forming apparatus. The image selector corresponds to a user interface 240 for selecting an image displayed on the display screen 205 using the mouse cursor to select a predetermined menu. The image displayed on the display screen 205 of the image forming apparatus may be directly input to the image forming apparatus from an external digital apparatus 235 using a PictBridge unit 225. The image may be directly input without using a host device such as a personal computer (PC) connected to the image forming apparatus. Also, an image stored in the image storage unit 215 may be displayed on the display screen 205.

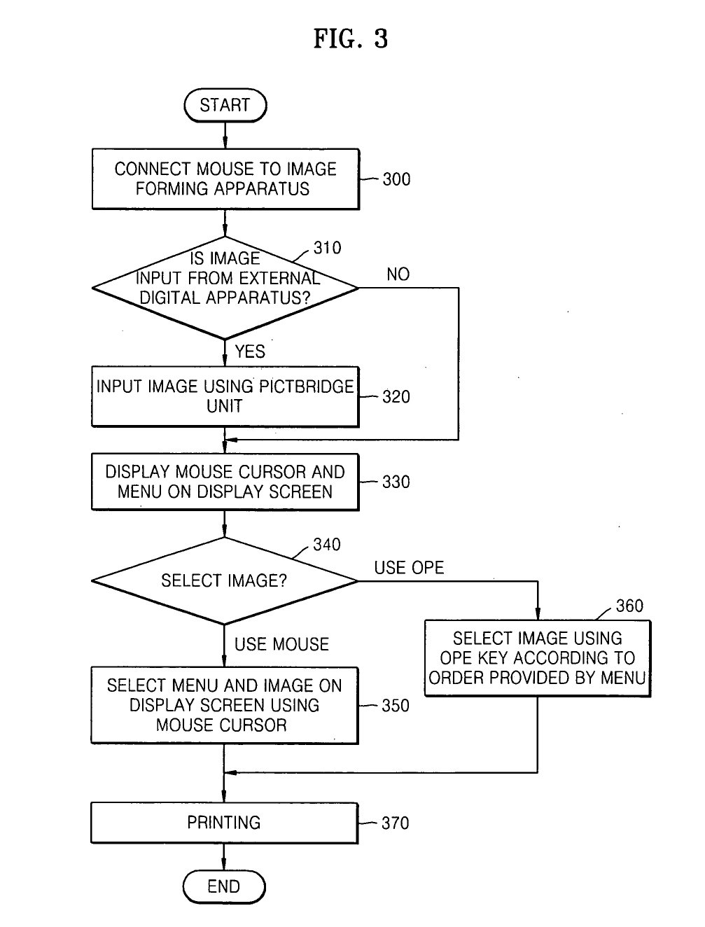

FIG. 3 is a flowchart of a method for selecting an image using a mouse in an image forming apparatus, including a display screen, such as an MFP or a photo printer, according to an exemplary embodiment of the present invention.

First, a mouse is connected to the image forming apparatus such (operation 300). Then, a determination is made as to whether an image is to be input to the image forming apparatus directly from an external digital apparatus such as a digital camera and a memory card (operation 310). If such an image exists, the image is directly input to the image forming apparatus using a PictBridge unit (operation 320). When such an image does not exist, an operation 330 is performed.

A menu required by a user is then displayed on a display screen of an LCD unit (operation 330). Also, a mouse cursor is displayed on the display screen after a mouse driver is installed in the image forming apparatus (operation 330).

The user may select a preferred menu by moving the mouse cursor on the display screen of the LCD unit (operation 340). Therefore, the user may easily find a preferred image by selecting a preferred menu using the mouse (operation 350). Also, images input using the PictBridge unit are displayed on the display screen of the LCD unit (operation 350) when the user selects a menu using the mouse cursor. Next, the user selects an image to be printed and inputs a print command using the mouse (operation 370). Image selection using the mouse may be performed using a predetermined menu. The menu may include an image enlargement menu for enlarging an image on the display screen and a resolution menu for selecting a resolution to facilitate improvement of a printing speed.

When image selection is performed using an operation panel (OPE) in the operation 340, the image is selected using a predetermined menu order (operation 360) and printed (operation 370).

According to the method and apparatus for selecting an image in an image forming apparatus according to an exemplary embodiment of the present invention, a user may easily select a preferred image to be printed using a mouse.

An image to be printed can be directly input to an image forming apparatus using a PictBridge unit.

Also, a portion of a preferred image displayed on a display screen of an LCD unit may be selected using a mouse, so that the selected portion of the image may be printed without using a computer.

The invention can also be embodied as computer readable codes on a computer readable recording medium. The computer readable recording medium is any data storage device that can store data which can be read by a computer system. Examples of the computer readable recording medium include read-only memory (ROM), random-access memory (RAM), CD-ROMs, magnetic tapes, floppy disks, and optical data storage devices.

While the present invention has been particularly shown and described with reference to certain exemplary embodiments thereof, it will be understood by those of ordinary skill in the art that various changes in form and details may be made therein without departing from the spirit and scope of the invention as defined by the appended claims and their equivalents.

What is claimed is:

1. A method of selecting an image in an image forming apparatus comprising a display screen, the method comprising:
connecting a mouse to the image forming apparatus;
allowing a cursor of the mouse to move on the display screen; and
selecting an image displayed on the display screen using the cursor of the mouse.

2. The method of claim 1, wherein the image forming apparatus comprises a USB (universal serial bus) host function, and the image forming apparatus is connected to the mouse through a USB port.

3. The method of claim 1, wherein the image displayed on the display screen is input to the image forming apparatus directly from an external digital image device without using a host device connected to the image forming apparatus.

4. The method of claim 1, wherein the selecting of the image comprises selectively choosing a portion of the image.

5. The method of claim 1, wherein the selecting of the image comprises using a menu, and the menu comprises an image enlargement menu for enlarging the image on the display screen.

6. The method of claim 5, wherein the menu further comprises a resolution menu for selecting an image resolution in order to improve a printing speed.

7. An apparatus for selecting an image in an image forming apparatus comprising a display screen, the apparatus comprising:
a mouse connected to the image forming apparatus;
a mouse driver installed in the image forming apparatus which allows a cursor of the mouse to move on the display screen; and
an image selector for selecting an image displayed on the display screen using the cursor of the mouse.

8. The apparatus of claim 7, wherein the image forming apparatus comprises a USB (universal serial bus) host function, and the image forming apparatus is connected to the mouse through a USB port.

9. The apparatus of claim 7, wherein the image displayed on the display screen is input to the image forming apparatus directly from an external digital image device without using a host device connected to the image forming apparatus.
